(19) United States
(12) Patent Application Publication
(10) Pub. No.: US 2025/0158865 A1
(43) Pub. Date: May 15, 2025

(54) NON-LINEAR DATA TO REDUNDANT SYMBOL MAPPING

(71) Applicant: QUALCOMM Incorporated, San Diego, CA (US)

(72) Inventors: Stelios STEFANATOS, San Diego, CA (US); Iyab Issam SAKHNINI, San Diego, CA (US); Preeti KUMARI, San Diego, CA (US); Sony AKKARAKARAN, Poway, CA (US); Junyi LI, Greentown, PA (US)

(21) Appl. No.: 18/715,358

(22) PCT Filed: Jan. 11, 2023
(86) PCT No.: PCT/US2023/060444

§ 371 Date: May 31, 2024

(30) Foreign Application Priority Data
Jan. 13, 2022 (GR) 20220100028

(51) Int. Cl. H04L 27/26; H04B 7/06; H04W 72/231; H04W 72/40

(52) U.S. Cl. CPC H04L 27/26132; H04B 7/06952; H04L 27/2614; H04W 72/231; H04W 72/40

(57) ABSTRACT

Methods, systems, and devices for wireless communication are described. A transmitting device may precode, according to a configuration, redundant symbols and data symbols to generate a message, the configuration comprising a non-linear precoding configuration. The transmitting device may transmit, to a receiving device, an indication of the configuration. The transmitting device may transmit the message to the receiving device according to the configuration.

### CROSS REFERENCES

The present Application is a 371 national stage filing of International PCT Application No. PCT/US2023/060444 by STEFANATOS et al., entitled “NON-LINEAR DATA TO REDUNDANT SYMBOL MAPPING,” filed Jan. 11, 2023; and claims priority to Greek Patent Application No. 20220100028 by STEFANATOS et al., entitled NON-LINEAR DATA TO REDUNDANT SYMBOL MAPPING,” filed Jan. 13, 2022, each of which is assigned to the assignee hereof, and each of which is expressly incorporated by reference in its entirety herein.

### FIELD OF TECHNOLOGY

The following relates to wireless communication, including non-linear data to redundant symbol mapping.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

The described techniques relate to improved methods, systems, devices, and apparatuses that support non-linear data to redundant symbol mapping. Generally, the described techniques provide for using a linear or a non-linear precoding configuration for message transmission. For example, a transmitting device may precode redundant and data symbols according to a non-linear precoding configuration. The transmitting device may identify or otherwise select the non-linear precoding configuration for the message and select the number of redundant symbols based on the number of data symbols being conveyed in the data message. The transmitting device transmits or otherwise provides an indication of the configuration being used for the message to the receiving device and transmits the message according to the precoding configuration.

A method for wireless communication at a transmitting device is described. The method may include precoding, according to a configuration, redundant symbols and data symbols to generate a message, the configuration including a non-linear precoding configuration, transmitting, to a receiving device, an indication of the configuration, and transmitting the message to the receiving device according to the configuration.

An apparatus for wireless communication at a transmitting device is described. The apparatus may include a processor, memory coupled with the processor, and instructions stored in the memory. The instructions may be executable by the processor to cause the apparatus to precode, according to a configuration, redundant symbols and data symbols to generate a message, the configuration including a non-linear precoding configuration, transmit, to a receiving device, an indication of the configuration, and transmit the message to the receiving device according to the configuration.

Another apparatus for wireless communication at a transmitting device is described. The apparatus may include means for precoding, according to a configuration, redundant symbols and data symbols to generate a message, the configuration including a non-linear precoding configuration, means for transmitting, to a receiving device, an indication of the configuration, and means for transmitting the message to the receiving device according to the configuration.

A non-transitory computer-readable medium storing code for wireless communication at a transmitting device is described. The code may include instructions executable by a processor to precode, according to a configuration, redundant symbols and data symbols to generate a message, the configuration including a non-linear precoding configuration, transmit, to a receiving device, an indication of the configuration, and transmit the message to the receiving device according to the configuration.

Some examples of the method, apparatuses, and non-transitory computer-readable medium described herein may further include operations, features, means, or instructions for selecting, based on the configuration and a number of data symbols, a number of redundant bits associated the redundant symbols. In some examples of the method, apparatuses, and non-transitory computer-readable medium described herein, transmitting the indication of the configuration may include operations, features, means, or instructions for transmitting an indication of a redundant symbol-to-data symbol mapping for the message, an optimization formulation used to determine a number of redundant symbols from the data symbols, an index associated with the configuration, or any combination thereof.

In some examples of the method, apparatuses, and non-transitory computer-readable medium described herein, the indication may be transmitted in a downlink control information (DCI) message, a radio resource control (RRC) message, a medium access control-control element (MAC-CE) message, a sidelink control information (SCI) message, or any combination thereof. In some examples of the method, apparatuses, and non-transitory computer-readable medium described herein, the indication may be valid for a time period. Some examples of the method, apparatuses, and non-transitory computer-readable medium described herein may further include operations, features, means, or instructions for selecting a precoding configuration from a set of multiple available precoding configurations based on a number of data symbols.

In some examples of the method, apparatuses, and non-transitory computer-readable medium described herein, transmitting the indication of the configuration may include operations, features, means, or instructions for transmitting an indication of the precoding configuration. In some examples of the method, apparatuses, and non-transitory computer-readable medium described herein, the non-linear precoding configuration may include operations, features, means, or instructions for permutating redundant symbols and data bits associated with the data symbols based on a size of the message and a number of the data symbols.

Some examples of the method, apparatuses, and non-transitory computer-readable medium described herein may further include operations, features, means, or instructions for receiving an indication of a preferred configuration from the receiving device, where the configuration may be based on the preferred configuration. In some examples of the method, apparatuses, and non-transitory computer-readable medium described herein, the non-linear precoding configuration includes a number of redundant symbols, a peak-to-average-power ratio (PAPR) threshold for data bits associated with the data symbols, a difference between a size of the message using the non-linear precoding configuration and a linear precoding configuration, or any combination thereof.

A method for wireless communication at a receiving device is described. The method may include receiving, from a transmitting device, an indication of a configuration, the configuration including a non-linear precoding configuration, receiving a message from the transmitting device according to the configuration, the message including redundant symbols and data symbols, and decoding the message according to the non-linear precoding configuration.

An apparatus for wireless communication at a receiving device is described. The apparatus may include a processor, memory coupled with the processor, and instructions stored in the memory. The instructions may be executable by the processor to cause the apparatus to receive, from a transmitting device, an indication of a configuration, the configuration including a non-linear precoding configuration, receive a message from the transmitting device according to the configuration, the message including redundant symbols and data symbols, and decode the message according to the non-linear precoding configuration.

Another apparatus for wireless communication at a receiving device is described. The apparatus may include means for receiving, from a transmitting device, an indication of a configuration, the configuration including a non-linear precoding configuration, means for receiving a message from the transmitting device according to the configuration, the message including redundant symbols and data symbols, and means for decoding the message according to the non-linear precoding configuration.

A non-transitory computer-readable medium storing code for wireless communication at a receiving device is described. The code may include instructions executable by a processor to receive, from a transmitting device, an indication of a configuration, the configuration including a non-linear precoding configuration, receive a message from the transmitting device according to the configuration, the message including redundant symbols and data symbols, and decode the message according to the non-linear precoding configuration.

In some examples of the method, apparatuses, and non-transitory computer-readable medium described herein, decoding the message may include operations, features, means, or instructions for identifying a number of redundant symbols based on the configuration and a number of data symbols. In some examples of the method, apparatuses, and non-transitory computer-readable medium described herein, receiving the indication of the configuration may include operations, features, means, or instructions for receiving an indication of a redundant symbol-to-data symbol mapping for the message, an optimization formulation used to determine the redundant symbols from the data symbols, an index associated with the configuration, or any combination thereof.

In some examples of the method, apparatuses, and non-transitory computer-readable medium described herein, the indication may be received in a DCI message, an RRC message, a MAC-CE message, a SCI message, or any combination thereof. In some examples of the method, apparatuses, and non-transitory computer-readable medium described herein, the indication may be valid for a time period. In some examples of the method, apparatuses, and non-transitory computer-readable medium described herein, receiving the indication may include operations, features, means, or instructions for receiving an indication of a precoding configuration for the message from the transmitting device, the precoding configuration selected from a set of multiple available precoding configurations based on a number of data symbols.

In some examples of the method, apparatuses, and non-transitory computer-readable medium described herein, the non-linear precoding configuration includes a permutation of redundant symbols and data symbols based on a size of the message and a number of the data symbols. Some examples of the method, apparatuses, and non-transitory computer-readable medium described herein may further include operations, features, means, or instructions for transmitting an indication of a preferred configuration to the transmitting device, where the configuration may be based on the preferred configuration. In some examples of the method, apparatuses, and non-transitory computer-readable medium described herein, the non-linear precoding configuration includes a number of redundant symbols, a PAPR threshold for data bits associated with the data symbols, a difference between a size of the message using the non-linear precoding configuration and a linear precoding configuration, or any combination thereof.

### BRIEF DESCRIPTION OF THE DRAWINGS

FIG. 1 illustrates an example of a wireless communications system that supports non-linear data to redundant symbol mapping in accordance with aspects of the present disclosure.

FIG. 2 illustrates an example of a wireless communication system that supports non-linear data to redundant symbol mapping in accordance with aspects of the present disclosure.

FIG. 3 illustrates an example of a coding configuration that supports non-linear data to redundant symbol mapping in accordance with aspects of the present disclosure.

FIG. 4 illustrates an example of a process that supports non-linear data to redundant symbol mapping in accordance with aspects of the present disclosure.

FIGS. 5 and 6 show block diagrams of devices that support non-linear data to redundant symbol mapping in accordance with aspects of the present disclosure.

FIG. 7 shows a block diagram of a communications manager that supports non-linear data to redundant symbol mapping in accordance with aspects of the present disclosure.

FIG. 8 shows a diagram of a system including a UE that supports non-linear data to redundant symbol mapping in accordance with aspects of the present disclosure.

FIG. 9 shows a diagram of a system including a base station that supports non-linear data to redundant symbol mapping in accordance with aspects of the present disclosure.

FIGS. 10 through 14 show flowcharts illustrating methods that support non-linear data to redundant symbol mapping in accordance with aspects of the present disclosure.

### DETAILED DESCRIPTION

Wireless communication systems generally use precoding operations for message transmissions carrying data bits as well as redundant bits. For example, the precoding operations generate a sufficient number of guard interval samples to match a required unique word sequence (e.g., using linear precoding techniques). These techniques permit the receiving device to exploit the redundant sub-carriers to improve data detection. The transmitting device and receiving device both know the linear precoding configuration being used, and are therefore in sync with regards to the size of the data message. Such precoding operations are generally applied given the cyclic prefix is limited by the restriction of the cyclic prefix length being greater than the channel delay spread. This may limit the waveform being used to support wireless communications.

Generally, the described techniques provide for using a linear or a non-linear precoding configuration for message transmission. For example, a transmitting device may precode redundant and data symbols according to a non-linear precoding configuration. The transmitting device may identify or otherwise select the non-linear precoding configuration for the message and select the number of redundant symbols based on the number of data symbols being conveyed in the data message. The transmitting device transmits or otherwise provides an indication of the configuration being used for the message to the receiving device and transmits the message according to the precoding configuration.

Aspects of the disclosure are initially described in the context of wireless communications systems. Aspects of the disclosure are further illustrated by and described herein with reference to apparatus diagrams, system diagrams, and flowcharts that relate to non-linear data to redundant symbol mapping.

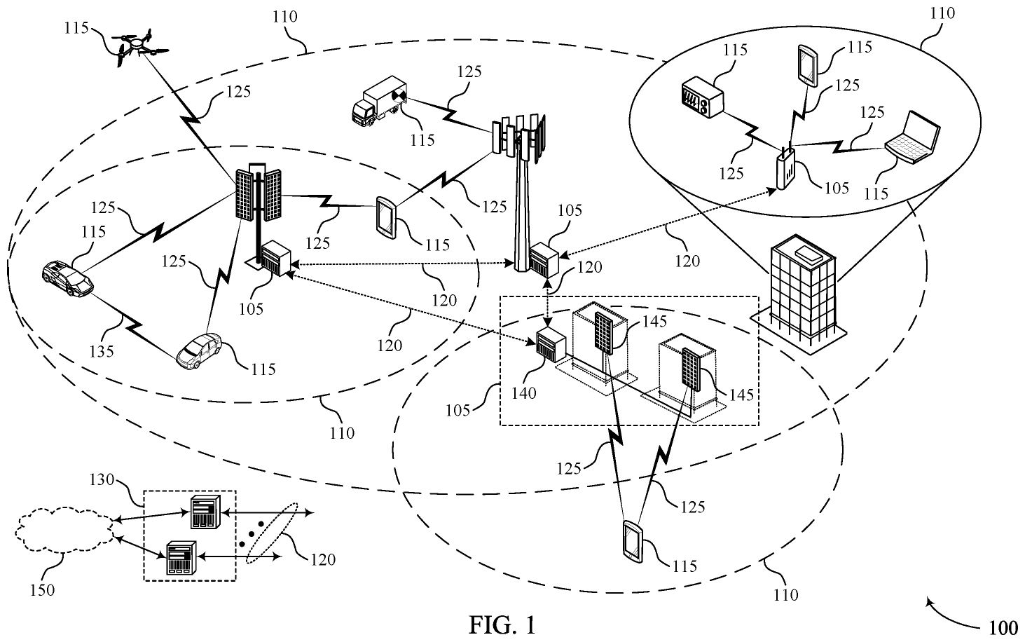

FIG. 1 illustrates an example of a wireless communications system 100 that supports non-linear data to redundant symbol mapping in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

In some examples, one or more components of the wireless communications system 100 may operate as or be referred to as a network node. As used herein, a network node may refer to any UE 115, base station 105, entity of a core network 130, apparatus, device, or computing system configured to perform any techniques described herein. For example, a network node may be a UE 115. As another example, a network node may be a base station 105. As another example, a first network node may be configured to communicate with a second network node or a third network node. In one aspect of this example, the first network node may be a UE 115, the second network node may be a base station 105, and the third network node may be a UE 115. In another aspect of this example, the first network node may be a UE 115, the second network node may be a base station 105, and the third network node may be a base station 105. In yet other aspects of this example, the first, second, and third network nodes may be different. Similarly, reference to a UE 115, a base station 105, an apparatus, a device, or a computing system may include disclosure of the UE 115, base station 105, apparatus, device, or computing system being a network node. For example, disclosure that a UE 115 is configured to receive information from a base station 105 also discloses that a first network node is configured to receive information from a second network node. In this example, consistent with this disclosure, the first network node may refer to a first UE 115, a first base station 105, a first apparatus, a first device, or a first computing system configured to receive the information; and the second network node may refer to a second UE 115, a second base station 105, a second apparatus, a second device, or a second computing system.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links. In some examples, base stations 105 may communicate with one another via a midhaul communication link (e.g., in accordance with a midhaul interface protocol) or a fronthaul communication link (e.g., in accordance with a fronthaul interface protocol), or any combination thereof. The backhaul links 120, midhaul communication links, or fronthaul communication links may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 125.

One or more of the base stations 105 described herein may include or may be referred to by a person having ordinary skill in the art as a base transceiver station, a radio base station, an NR base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

In some examples, a base station 105 may be implemented in a disaggregated architecture (e.g., a disaggregated base station architecture, a disaggregated RAN architecture), which may be configured to utilize a protocol stack that is physically or logically distributed among two or more base stations 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a base station 105 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof. An RU may also be referred to as a radio head, a smart radio head, a remote radio head (RRH), a remote radio unit (RRU), or a transmission reception point (TRP). One or more components of the base stations 105 in a disaggregated RAN architecture may be co-located, or one or more components of the base stations 105 may be located in distributed locations (e.g., separate physical locations). In some examples, one or more base stations 105 of a disaggregated RAN architecture may be implemented as virtual units (e.g., a virtual CU (VCU), a virtual DU (VDU), a virtual RU (VRU)).

The split of functionality between a CU, a DU, and an RU is flexible and may support different functionalities depending on which functions (e.g., network layer functions, protocol layer functions, baseband functions, RF functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some examples, the CU may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU. Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs).

In some cases, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU). A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some examples, a midhaul communication link or a fronthaul communication link may be implemented in accordance with an interface (e.g., a channel) between layers of a protocol stack supported by respective base stations 105 that are in communication via such communication links.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a ULE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described herein with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

A transmitting device (e.g., a UE 115 and/or base station 105) may precode, according to a configuration, redundant symbols and data symbols to generate a message, the configuration comprising a non-linear precoding configuration. The transmitting device may transmit, to a receiving device, an indication of the configuration. The transmitting device may transmit the message to the receiving device according to the configuration.

A receiving device (e.g., a UE 115 and/or base station 105) may receive, from a transmitting device, an indication of a configuration, the configuration comprising a non-linear precoding configuration. The receiving device may receive the message from the transmitting device according to the configuration, the message comprising redundant symbols and data symbols. The receiving device may decode the message according to the non-linear precoding configuration.

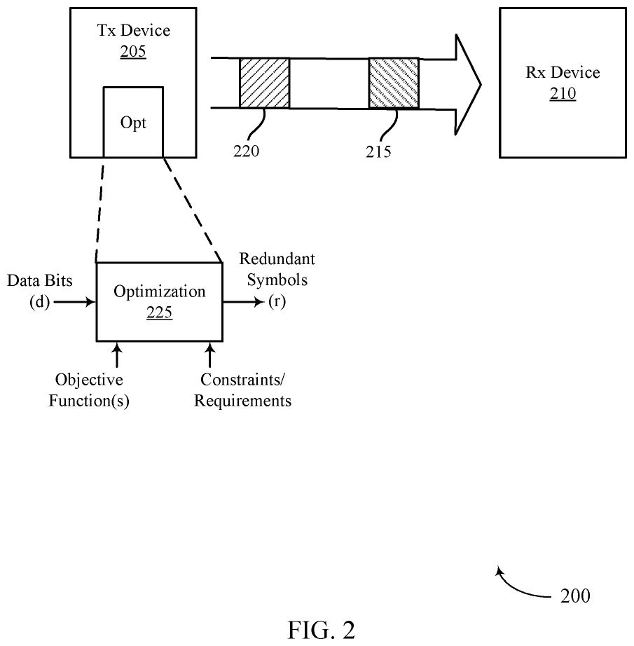

FIG. 2 illustrates an example of a wireless communication system 200 that supports non-linear data to redundant symbol mapping in accordance with aspects of the present disclosure. Wireless communication system 200 may implement aspects of wireless communication system 200. Wireless communication system 200 may include a transmitting device 205 and a receiving device 210, which may be examples of the corresponding devices described herein. For example, transmitting device 205 may refer to any wireless device, such as a UE and/or base station, performing a wireless transmission to a receiving device. Receiving device 210 may refer to any wireless device, such as a UE and/or base station, receiving a wireless transmission from a transmitting device.

Wireless communication system 200 may support combined operations, such as aspects of wireless communications, radar sensing, and the like, to achieve efficient resource utilization. For example, such combined operations may support enhanced accurate positioning techniques, shifts towards mmW frequency ranges, additional radar or other sensing operations (such as vehicle operations), and the like. In some examples, such combined operations may also be referred to as joint communication and radar (JCR). In JCR, the transmitted signal may serve multiple purposes. One purpose may include conveying information to a receiver, such as is accomplished with wireless communication systems. Another purpose may include a signal whose returns at the transmitting device may be used to detect targets/objects, such as radar.

However, this approach raises questions such as what is the appropriate waveform to use to support JCR. One waveform considered is the current waveform being used for wireless communications, such as an CP-OFDM waveform, e.g., when the CP-OFDM receiver modules are also used for radar sensing. However, this linear precoding configuration (e.g., using the CP-OFDM) approach may be limiting because the CP-OFDM waveform and corresponding receiver processing assume (e.g., are based on) the channel delay spread being smaller than the CP length. However, radar sensing applications may experience a propagation path that is more than (e.g., double) the transmitter-to-target link path, which may result in an effective channel with a larger delay spread than those experienced by communication link path lengths. When the target's return propagation delay is greater than the CP length, this may introduce inter-carrier and/or inter-symbol interference, thus degrading the sensing performance achievable by using the waveform. Accordingly, wireless communication system 200 supports an alternative waveform that can handle larger delay spreads.

One example of this may include a guard interval-OFDM (GI-OFDM) waveform, which allows for on the fly adaptation to the channel delay spread requirements, such as those imposed by radar sensing applications, as well as supporting cellular communications.

GI-OFDM increases the flexibility of OFDM to adjust to different channel delay spreads on the fly (e.g., using the same numerology), while avoiding the inter-symbol and/or inter-channel/carrier interference issues that conventional CP-OFDM techniques experiences under large delay spread. Broadly, GI-OFDM may include the input of the inverse fast-Fourier transform (IFFT) at the transmitting device being selected such that the time-domain samples at the IFFT output are such that the last Nu samples are a known sequence by both the transmitting device and the receiving device. The guard interval (GI) sequence may also be referred to as a “unique word” (UW), a message, and similar terminology. With the last Nu samples of the previous symbol (e.g., IFFT output) being the same UW as the current symbols GI, a CP is effectively introduced having a size of Nu samples. That is, the size of the GI (Nu) may be adjusted on-the-fly as needed, such as to accommodate large delay spreads and/or changes in the delay spread.

However, one aspect of the GI-OFDM approach is what should the transmitter IFFT input be in order to achieve generation of the UW at the IFFT output. One approach is the what is sometimes referred to as the systematic approach where reductant symbols (“r”) are inserted at the IFFT input in addition to the data-bearing symbols (“d”). The resulting set of symbols is first permuted, and it is the permuted version that is applied to the IFFT input according to the standard symbols to subcarriers (SC) mapping, taking into account guard tones, if any. One advantage of this approach is that the signal in frequency domain is exactly the same as conventional CP-OFDM (each sub-carrier carries one symbol). Another advantage is relatively simple transmitter implementation, since receiver complexity and processing flow is very similar to conventional CP-OFDM receive operations. Yet the question remains as to how to design the redundant symbols (e.g., d).

For example, given the permutation (P), a simple approach of selecting the redundant symbols may be as follows: Denote the input-output relation of the GI-OFDM IFFT as

$$[ \begin{matrix}x \\ u\end{matrix} ] = {F}_{N}^{- 1} BP [ \begin{matrix}d \\ r\end{matrix} ] ,$$

where d is the vector of the data symbols, r is the vector of the redundant symbols, P is the permutation matrix, B is the matrix representing the guard tone insertion (e.g., at the band edges), F is the IFFT operation, x is the first N_{fft}−Nu time-domain samples of the IFFT output, and u is the last Nu time-domain samples of the IFFT output, corresponding to the GI samples (e.g., UW samples). With the goal of the GI samples being equal to the UW (u), it can be easily shown that the redundant symbols (r) may be selected as r=M₂₂⁺(u−M₂₁d), where M₂₂⁺ and M₂₁ are submatrices of the matrix

$${F}_{N}^{- 1} BP = [ \begin{matrix}{M}_{11} & {M}_{12} \\ {M}_{2 I} & {M}_{22}\end{matrix} ]$$

with (.)⁺ denoting a (pseudo-) inverse operator. This approach renders computation of the redundant symbols (r) as a linear precoding of the data symbols (d) with the precoding matrix fixed (and known a-priori).

Accordingly, an advantage of the previous precoder-based design (e.g., based on the CP-OFDM) is that it generates the GI samples to exactly match the required UW sequence, is simple to implement (e.g., linear precoding of data), allows the receiver to exploit the redundant sub-carriers for data detection (since the receiver knows the precoder used), and the like. However, this approach also suffers from issues, such as there is no control on what the non-GI time-domain samples will look like (e.g., arbitrarily large samples may be generated, that cannot be supported by the digital-to-analog converter (DAC) module). For example, the time domain samples may have unacceptably large peak-to-average-power-ratio (PAPR). Depending on the numerology (number of subcarriers) and choice of permutation matrix, the linear precoding operation may be numerically unstable (condition number of M₂₂ is very large), result in arbitrarily large values for the redundant symbols at the IFFT input (that are not supported by the IFFT module), and the like.

Accordingly, aspects of the techniques discussed herein provide a more sophisticated approach for the design of the redundant symbols that satisfies/optimizes more than one conditions/key performance indicators (KPIs) instead of just rendering the GI samples equal to a pre-specified sequence. Although these techniques are generally described herein with reference to the systematic design approach discussed above, these techniques may equally apply to any GI-OFDM design with redundant symbols.

Such limitations of the previous approaches are that they rely on fixed precoding of the data to generate the redundant symbol values. This fixed precoding operation (e.g., linear precoding configuration) effectively imposes an optimization constraint that limits the performance with respect to different/additional KPIs other than (exact) generation of the GI samples. Accordingly, the techniques described herein provide for, given a permutation matrix, the redundant symbol values being obtained as a generally non-linear transformation of the data symbols, with the transformation itself dependent on the data (e.g., the transformation for any given set of data is not known beforehand). However, with the transformation being data-dependent, the receiver cannot be made aware of the transformation being used, accordingly the receiver needs to be informed about this approach being applied in order to avoid the receiver attempting to use the redundant SCs for decoding purposes as is done under conventional fixed linear precoding approaches. Accordingly, aspects of the techniques described herein also provide for the receiver being made aware of the data-dependent transformation (e.g., either using (pre)configuration and/or on-the-fly signaling).

One example of such techniques described herein may include, given a permutation (e.g., pre-configured or previously agreed upon between the two communicating nodes), the transmitter may identify the optimal redundant symbols (r). In one non-limiting example, this may be done by solving the following optimization problem: find r that minimized J(r) subject to constraints/requirements involving r. J(r), in this context, may refer to a cost function, such as a norm of the difference between the generated GI and the UW samples. Some examples of the additional constraints may include, but are not limited to, no element of r should have a modulus exceeding a maximum value, the PAPR of the non-GI part of the IFFT output should be within a limit, the GI samples do not differ from the UW samples by some margin (some vector norm could be used to measure the difference of the resulting GI with the intended UW), and the like. Generally, the solution of the problem (values of r) depends on the data d, and typically the relation between r and d is not available in closed form (such as in a linear precoding operation).

According, aspects of the techniques described herein provide for transmitting device 205 to precode redundant symbols and data symbols to generate a message. The precoding may be performed according to a configuration, such as a non-linear precoding configuration. The non-linear precoding configuration may include transmitting device 205 generating an GI-OFDM waveform structure supporting JCR purposes. Transmitting device 205 may transmit or otherwise provide (and receiving device 210 may receive or otherwise obtain) an indication 215 of the configuration used to precode the redundant/data symbols and then transmit message 220 to the receiving device 210 according to the configuration (e.g., the message 220 that was precoded using the non-linear precoding configuration). In some aspects, transmitting device 205 may include an optimization module 225 that optimizes the precoding operations according to the techniques described herein, such as based on various objective functions, based on various constraints/requirements (e.g., such as is discussed herein), and the like, to optimize for redundant symbols (r) based on the number of data bits (d). Generally, transmitting device 205 may identify or otherwise select the redundant symbols (e.g., optimize for (r)) based on the number of data symbols (e.g., based on the data bits (d)) and the configuration (e.g., using the non-linear precoding configuration).

In contrast to the fixed linear precoding approach discussed above where the receiving device 210 could, in principle, use the redundant SCs (e.g., redundant symbols) to improve data detection, this may no longer be possible under the techniques discussed herein. The redundant values are obtained by the transmitting device 205 solving an optimization problem (e.g., using optimization module 225) whose formulation may be unknown by the receiving device 210. Accordingly, the receiving device 210 is unaware of how the redundant symbols are related to the data (e.g., the transmitting device 205, due to environment dynamics, may change the objective functions, relax constraint(s), etc., as needed, without informing the receiving device 210. Even if the receiving device 210 knew the optimization problem the transmitting device 205 solved to get the redundant values, the resulting data symbols to redundant symbols mapping will, in general, be highly complex (non-linear) and computationally demanding, rendering its utilization impractical. The receiving device 210 needs to know what mapping is applied in order to proceed utilizing the redundant SCs for data detection, or not (at its own discretion).

Even though some aspects of these techniques may discard some of the redundant symbols by the receiver, which may result in a reduction in detection performance, this might as well be the choice made by the transmitting device 205 to improve the waveform properties to achieve other purposes, such as improved radar sensing. To that end, the transmitting device 205 may send a control signal (e.g., indication 215), prior the data transmission (e.g., message 220), that carries or otherwise conveys an indication of the data symbols to redundant symbols mapping (e.g., an indication of the (non-)linear precoding, an indication of the optimization problem formulation used to find the redundant SCs values from the data, and the like. In some examples, the indication 215 may be carried or otherwise conveyed in a downlink control information (DCI) message, a sidelink control information (SCI) message, a radio resource control (RRC) message, a medium access control-control element (MAC-CE) message, and the like. In some examples, the indication 215 may be valid for a specific time period.

Accordingly, in some examples the transmitting device 205 may transmit or otherwise provide (and receiving device 210 may receive or otherwise obtain) the indication 215 identifying or otherwise indicating the redundant symbol-to-data symbol mapping used for the message 220, the optimization formulation (e.g., objective function(s) and/or constraint(s)/requirement(s)) used to determine the redundant symbols from the data symbols, and/or an index to the configuration (e.g., an index to whether the configuration uses linear or non-linear precoding).

One approach to provide the indication 215 is to have a (pre)configured table with elements (indices) corresponding to (implicit or explicit) mappings of data SCs to redundant SCs, as well as the case where the transmitting device 205 does not inform the receiving device 210 about the mapping. For example, the table may have three options (e.g., such as when the indication 215 uses two bits). One option may include the indication of the redundant SCs being generated as conventional linear precoding of data SCs. Another option may include the indication of the redundant SCs being generated as the solution of a known optimization problem (that may or may not have a closed form solution). Another option may include the indication of an arbitrary (e.g., unknown) selection of redundant SCs by the transmitting device 205 (this option may indicate that the receiving device 210 may make no effort to utilize the redundant SCs to improve detection). As discussed, the mapping indication (e.g., indication 215) may be part of DCI, RRC, MAC-CE, SCI (SCI1 and/or SCI2) signaling.

As also discussed, in some examples the indication 215 may be valid for a time period. For example, the indication could be such that it is to be considered valid for a series of following transmissions, such as for the following X transmissions, until a timer expires, until a new indication message is received (with an updated indication), for all transmissions following a pattern (e.g., transmissions with a certain periodicity or transmissions occupying a specified set of RBs/subchannels), and the like. These aspects (e.g., the valid time period duration) could be (pre)configured or indicated on-the-fly by the control message.

In some examples, the configuration may be configured to be restricted to a set of pre-specified data dependent linear precoding configurations. For example, the transmitting device 205 may identify or otherwise select a precoding configuration from a plurality of available precoding configuration (e.g., based on the number of data symbols). In this example, the indication 215 may provide an explicit and/or implicit indication of the selected precoding configuration.

That is, the techniques discussed herein allow for arbitrary problem optimization that will, in general, result in a solution (r) that cannot be represented as a linear precoding of the data (d). One approach towards avoiding long computation times for solving the non-linear optimization problem, is to constraint the solution to a linear precoding solution, with the precoder obtained from a family of (pre)configured data-dependent precoders. For example if precoders of a family Qf={Q1(d), Q2(d), . . . , QN(d)} is considered (note each member of the family is a known function of the data), the precoder Qi may be selected which results in r=Qi(d) d that minimizes a cost functions (and satisfies some constraints). One benefit to this approach is that the transmitting device 205 only needs to search the solution (e.g., select the precoding configuration) over a finite number of possible solutions. Transmitting device 205 may indicate the precoder (e.g., precoding configuration) being used to the receiving device 210 (e.g., point to the index from a preconfigured codebook). The receiving device 210 may utilize this information to take the redundant symbols into account (provides more feasible approach than knowledge of an arbitrary complexity non-linear problem formulation).

Aspects of the techniques described herein may support selection and indication of the permutation used for the message 220. For example, the transmitting device 205 may permutate the redundant symbols and data bits (e.g., corresponding to the data symbols) based on the size of the message as well as the number of data symbols. The previous discussion considered a fixed (pre-selected/pre-configured) permutation operation (e.g., where the permutation is data-independent). However, according to the techniques discussed herein the permutation may also be data-dependent and can be optimized as well. For example, this may follow similar techniques as described for the computation of the redundant SCs. That is, an optimization problem may be formulated (e.g., based on optimization module 225) that includes the permutation as one of the optimization variables. A first example may include the permutation matrix being jointly optimized along with the redundant symbols (e.g., as discussed above, but now using both r and P as optimization variables). A second example may include the mapping of data to redundant symbols being pre-specified as a function of P (e.g., conventional linear precoding), which may include an optimization problem then being formulated with only P as an optimization variable (e.g., the number of redundant symbols may be computed after P has been found using the pre-specified mapping). When a data-dependent permutation is used, it may be helpful that the receiving device 210 is aware of it (otherwise the receiving device 210 may not know which SCs are data and which SCs are redundant). In some examples, the same control signaling principle used for informing the receiving device 210 about the data to redundant symbols mapping can be used to inform the receiving device 210. That is, in the situation where both the permutation and redundant symbols depend on the data, the control signal may be used to indicate both.

In some examples, the receiving device 210 may have a preference on the configuration used by the transmitting device 205. For example, the receiving device 210 may transmit or otherwise provide (and transmitting device 205 may receive or otherwise obtain) an indication of a preferred configuration. If the receiving device 210 experiences an unreliable channel, it may want to utilize the redundant subcarriers to improve detection, and therefore may benefit from knowing the mapping used (e.g., the configuration). Additionally, for complexity reasons the receiving device 210 may prefer the mapping to be the fixed mapping (e.g., the fixed, linear precoding). In other cases, the receiving device 210 may be able to decode the data without needing to employ the redundant SCs, hence there may be no need/benefit to the receiving device 210 knowing the mapping.

Accordingly, the receiving device 210 may indicate its preference (e.g., the preferred configuration) to the transmitting device 205. In Uu operations, the indication may be provided via uplink control information (UCI) and/or MAC-CE. In PC5 operations, the indication may be provided via SCI 1 or 2, MAC-CE or as part of a physical sidelink feedback channel (PSFCH) transmission. For the case of PSFCH transmission being used to convey the indication, the set of acknowledge/negative-acknowledge (ACK/NACK) sequences may be enhanced to contain information about the preferred scheme (e.g., no need to know mapping, need to know mapping, need to apply conventional precoding, etc.).

Accordingly, the techniques discussed herein provide a new approach to GI-OFDM waveform generation that allows for improved performance according to the transmitting device 205 (and possibly receiving device 210) requirements. The performance may be an improvement over conventional (linear precoder based) GI-OFDM generation. With the data to redundant symbols mapping no longer being fixed (e.g., known) the transmitting device 205 informs the receiving device 210 about the scheme being used (so the receiving device 210 can use or discard data symbols for data detection). Even though discarding some redundant symbols may result in a small decrease in detection performance, this might as well be the choice made by the transmitting device 205 to improve the waveform properties to achieve other purposes, such as improved radar sensing operations.

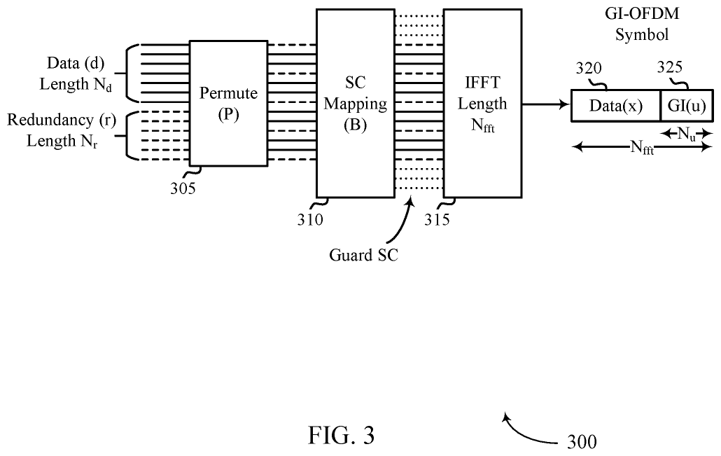

FIG. 3 illustrates an example of a coding configuration 300 that supports non-linear data to redundant symbol mapping in accordance with aspects of the present disclosure. Coding configuration 300 may implement aspects of wireless communication systems 100 and/or 200. Aspects of coding configuration 300 may be implemented at or implemented by a transmitting device, which may be example of the corresponding device(s) (e.g., UE and/or base station) described herein.

As discussed above, aspects of the techniques described herein provide a mechanism for a transmitting device to select between a linear or a non-linear precoding configuration for a message transmission. For example, the configuration (e.g., the non-linear precoding configuration) may be used for an optimization function/procedure performed by the transmitting device to precode the message containing data bits (d) having a length N_{d} and one or more redundancy symbols (r) having a redundant symbol length Nᵣ in a non-linear fashion.

For example, for a given permutation 305 (e.g., permutation (P)) that has been preconfigured or otherwise previously agreed to by the transmitting and receiving devices), the transmitting device may select, determine, or otherwise identify the number of optimal redundant symbols (r). Permutating the data (d) and the redundant symbols (r) may include mixing, ordering, or otherwise arranging the data (d) and the redundant symbols (r) according to a permutation scheme, such as is discussed above. The permutated data (d) and redundant symbols (r) may be output to a SC mapping (B) 310 where the data (d) and redundant symbols (r) are mapped to different subcarriers. The SC mapping (B) 310 may also include adding one or more guard SCs, such as at the edges of the bandwidth. The output of the SC mapping (B) 310 may be input to an IFFT function 315 having a length Nm. The output of the IFFT function 315 may be, at least to some degree, a message for a GI-OFDM symbol. The message may include data 320 and GI 325 (e.g., redundant symbols) having a length Nu, with the message having a message size of Nm.

For example, the transmitting device may solve an optimization problem (e.g., using an optimization module) in a manner that minimizes J(r), subject to various constraints/requirements involving r. As discussed above, J(r) may generally correspond to the cost function of selecting a particular value of r. The cost function may generally correspond to a trade-off in the difference between the generated GI and the UW. Some examples of the constraint(s)/requirement(s) may include, but are not limited to, that no element of r should have a modulus exceeding a maximum value, the PAPR of the non-GI part of the IFFT output should be within a limit, the GI samples should not differ from the UW samples by some margin, and the like.

Accordingly, the transmitting device may transmit an indication of the configuration used to prepare the message to the receiving device and then transmit the message according to the indicated configuration (e.g., a non-linear precoding configuration). The receiving device may decode the message according to the non-linear precoding configuration. For example and as the optimization function may be based, at least to some degree, on the number of data bits, the receiving device may identify or otherwise determine the number of redundant symbols based on the number of data symbols (as well as the indicated configuration).

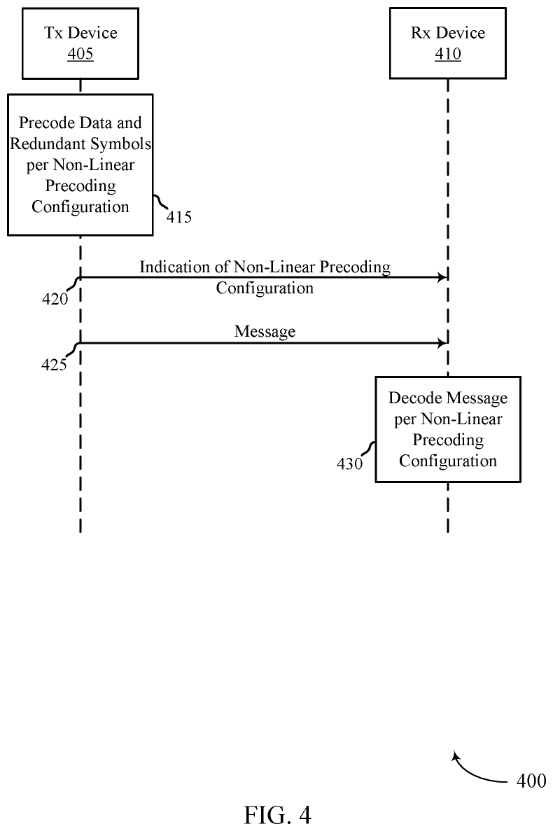

FIG. 4 illustrates an example of a process 400 that supports non-linear data to redundant symbol mapping in accordance with aspects of the present disclosure. Process 400 may implement aspects of wireless communication systems 100 and/or 200 and/or aspects of coding configuration 300. Aspects of process 400 may be implemented at or implemented by a transmitting device 405 and/or a receiving device 410, which may be examples of the corresponding devices described herein.

At 415, transmitting device 405 may precode redundant symbols and data symbols to generate a message according to a configuration. In some examples, the configuration includes a linear configuration or a non-linear configuration. For example, the non-linear precoding configuration may include the number of redundant symbols (r) being selected based at least in part on the number of data symbols (d) (e.g., r is a function of d). In some examples, the may include transmitting device 405 identifying, determining, or otherwise selecting the number of redundant symbols, according to the configuration, based at least in some aspects on the number of data symbols.

Generally, the non-linear precoding configuration (e.g., the optimization function) may include or otherwise be based on the number of redundant symbols, a PAPR threshold for the message, a difference between (e.g., trade-off) the message size using the non-linear precoding configuration or the linear precoding configuration, and the like.

At 420, the transmitting device 405 may transmit or otherwise provide (and receiving device 410 may receive or otherwise obtain) an indication of the configuration (e.g., the non-linear precoding configuration). The indication may be transmitted or otherwise provided via DCI signaling, SCI signaling, RRC signaling, MAC-CE signaling, and the like. The indication may include an explicit indication of the optimization scheme. The indication may include an indication of an index associated with a specific precoding configuration. The indication may include an indication of a redundant symbol-to-data symbol mapping for the message. The indication may include an indication or otherwise identify the optimization formula used by transmitting device 405.

Accordingly and at 425, the transmitting device 405 may transmit or otherwise provide (and receiving device 410 may receive or otherwise obtain) the message according to the configuration. For example, the message may include data symbols and redundant symbols configured according to the configuration.

At 430, the receiving device 410 may decode the message according to the indicated configuration (e.g., the non-linear precoding configuration). For example, the receiving device 410 may identify or otherwise determine the number of redundant symbols based on the indication and then decode the message accordingly. For example, the receiving device 410 may use the redundant symbol-to-data symbol mapping, optimization formula, and the like, when decoding the message.

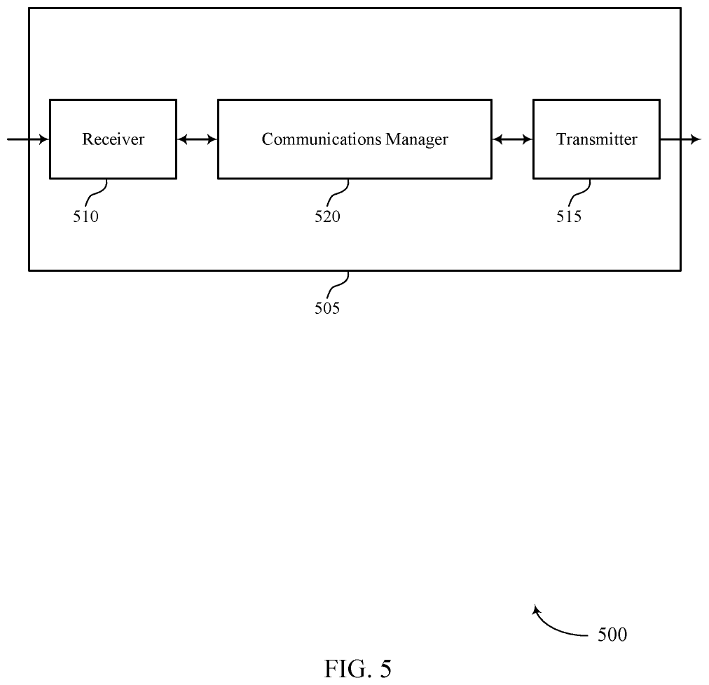

FIG. 5 shows a block diagram 500 of a device 505 that supports non-linear data to redundant symbol mapping in accordance with aspects of the present disclosure. The device 505 may be an example of aspects of a UE 115 or a base station 105 as described herein. The device 505 may include a receiver 510, a transmitter 515, and a communications manager 520. The device 505 may also include a processor (not shown). Each of these components may be in communication with one another (e.g., via one or more buses).

The receiver 510 may provide a means for receiving information such as packets, user data, control information, or any combination thereof associated with various information channels (e.g., control channels, data channels, information channels related to non-linear data to redundant symbol mapping). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to non-linear data to redundant symbol mapping). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of non-linear data to redundant symbol mapping as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 520 may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communication at a transmitting device in accordance with examples as disclosed herein. For example, the communications manager 520 may be configured as or otherwise support a means for (e.g., when device 505 is configured or otherwise acting as a transmitting device) precoding, according to a configuration, redundant symbols and data symbols to generate a message, the configuration including a non-linear precoding configuration. The communications manager 520 may be configured as or otherwise support a means for transmitting, to a receiving device, an indication of the configuration. The communications manager 520 may be configured as or otherwise support a means for transmitting the message to the receiving device according to the configuration.

Additionally or alternatively, the communications manager 520 may support wireless communication at a receiving device in accordance with examples as disclosed herein. For example, the communications manager 520 may be configured as or otherwise support a means for (e.g., when device 505 is configured or otherwise acting as a receiving device) receiving, from a transmitting device, an indication of a configuration, the configuration including a non-linear precoding configuration. The communications manager 520 may be configured as or otherwise support a means for receiving the message from the transmitting device according to the configuration, the message including redundant symbols and data symbols. The communications manager 520 may be configured as or otherwise support a means for decoding the message according to the non-linear precoding configuration.

By including or configuring the communications manager 520 in accordance with examples as described herein, the device 505 (e.g., a processor controlling or otherwise coupled to the receiver 510, the transmitter 515, the communications manager 520, or any combination thereof) may support techniques for enabling multi-purpose waveform designs where the transmitting and receiving devices are in sync regarding the non-linear precoding configuration used to generate the message.

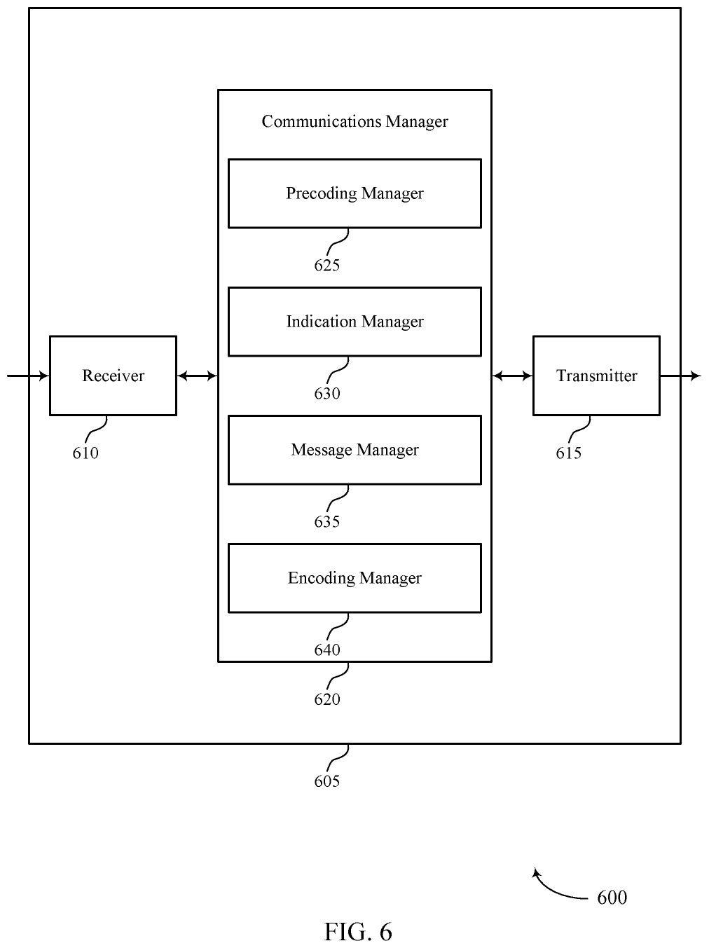

FIG. 6 shows a block diagram 600 of a device 605 that supports non-linear data to redundant symbol mapping in accordance with aspects of the present disclosure. The device 605 may be an example of aspects of a device 505, a UE 115, or a base station 105 as described herein. The device 605 may include a receiver 610, a transmitter 615, and a communications manager 620. The device 605 may also include a processor (not shown). Each of these components may be in communication with one another (e.g., via one or more buses).

The receiver 610 may provide a means for receiving information such as packets, user data, control information, or any combination thereof associated with various information channels (e.g., control channels, data channels, information channels related to non-linear data to redundant symbol mapping). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to non-linear data to redundant symbol mapping). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of non-linear data to redundant symbol mapping as described herein. For example, the communications manager 620 may include a precoding manager 625, an indication manager 630, a message manager 635, an encoding manager 640, or any combination thereof. The communications manager 620 may be an example of aspects of a communications manager 520 as described herein. In some examples, the communications manager 620, or various components thereof, may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communication at a transmitting device in accordance with examples as disclosed herein. The precoding manager 625 may be configured as or otherwise support a means for precoding, according to a configuration, redundant symbols and data symbols to generate a message, the configuration including a non-linear precoding configuration. The indication manager 630 may be configured as or otherwise support a means for transmitting, to a receiving device, an indication of the configuration. The message manager 635 may be configured as or otherwise support a means for transmitting the message to the receiving device according to the configuration.

Additionally or alternatively, the communications manager 620 may support wireless communication at a receiving device in accordance with examples as disclosed herein. The indication manager 630 may be configured as or otherwise support a means for receiving, from a transmitting device, an indication of a configuration, the configuration including a non-linear precoding configuration. The message manager 635 may be configured as or otherwise support a means for receiving the message from the transmitting device according to the configuration, the message including redundant symbols and data symbols. The encoding manager 640 may be configured as or otherwise support a means for decoding the message according to the non-linear precoding configuration.

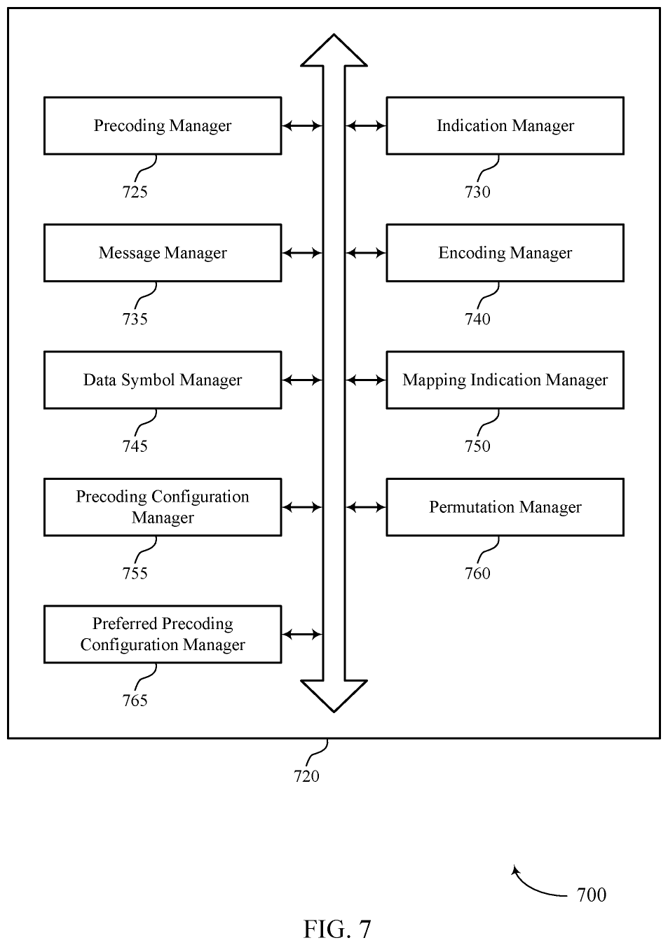

FIG. 7 shows a block diagram 700 of a communications manager 720 that supports non-linear data to redundant symbol mapping in accordance with aspects of the present disclosure. The communications manager 720 may be an example of aspects of a communications manager 520, a communications manager 620, or both, as described herein. The communications manager 720, or various components thereof, may be an example of means for performing various aspects of non-linear data to redundant symbol mapping as described herein. For example, the communications manager 720 may include a precoding manager 725, an indication manager 730, a message manager 735, an encoding manager 740, a data symbol manager 745, a mapping indication manager 750, a precoding configuration manager 755, a permutation manager 760, a preferred precoding configuration manager 765, or any combination thereof. Each of these components may communicate, directly or indirectly, with one another (e.g., via one or more buses).

The communications manager 720 may support wireless communication at a transmitting device in accordance with examples as disclosed herein. The precoding manager 725 may be configured as or otherwise support a means for precoding, according to a configuration, redundant symbols and data symbols to generate a message, the configuration including a non-linear precoding configuration. The indication manager 730 may be configured as or otherwise support a means for transmitting, to a receiving device, an indication of the configuration. The message manager 735 may be configured as or otherwise support a means for transmitting the message to the receiving device according to the configuration.

In some examples, the data symbol manager 745 may be configured as or otherwise support a means for selecting, based on the configuration and a number of data symbols, a number of redundant bits associated the redundant symbols.

In some examples, to support transmitting the indication of the configuration, the mapping indication manager 750 may be configured as or otherwise support a means for transmitting an indication of a redundant symbol-to-data symbol mapping for the message, an optimization formulation used to determine a number of redundant symbols from the data symbols, an index associated with the configuration, or any combination thereof. In some examples, the indication is transmitted in a DCI message, an RRC message, a MAC-CE message, a SCI message, or any combination thereof. In some examples, the indication is valid for a time period.

In some examples, the precoding configuration manager 755 may be configured as or otherwise support a means for selecting a precoding configuration from a set of multiple available precoding configurations based on a number of data symbols. In some examples, to support transmitting the indication of the configuration, the precoding configuration manager 755 may be configured as or otherwise support a means for transmitting an indication of the precoding configuration.

In some examples, to support non-linear precoding configuration, the permutation manager 760 may be configured as or otherwise support a means for permutating redundant symbols and data bits associated with the data symbols based on a size of the message and a number of the data symbols.

In some examples, the preferred precoding configuration manager 765 may be configured as or otherwise support a means for receiving an indication of a preferred configuration from the receiving device, where the configuration is based on the preferred configuration. In some examples, the non-linear precoding configuration includes a number of redundant symbols, a PAPR threshold for data bits associated with the data symbols, a difference between the size of the message using the non-linear precoding configuration and a linear precoding configuration, or any combination thereof.

Additionally or alternatively, the communications manager 720 may support wireless communication at a receiving device in accordance with examples as disclosed herein. In some examples, the indication manager 730 may be configured as or otherwise support a means for receiving, from a transmitting device, an indication of a configuration, the configuration including a non-linear precoding configuration. In some examples, the message manager 735 may be configured as or otherwise support a means for receiving the message from the transmitting device according to the configuration, the message including redundant symbols and data symbols. The encoding manager 740 may be configured as or otherwise support a means for decoding the message according to the non-linear precoding configuration.

In some examples, to support decoding the message, the data symbol manager 745 may be configured as or otherwise support a means for identifying a number of redundant symbols based on the configuration and a number of data symbols.

In some examples, to support receiving the indication of the configuration, the mapping indication manager 750 may be configured as or otherwise support a means for receiving an indication of a redundant symbol-to-data symbol mapping for the message, an optimization formulation used to determine the redundant symbols from the data symbols, an index associated with the configuration, or any combination thereof.

In some examples, the indication is received in a DCI message, an RRC message, a MAC-CE message, a SCI message, or any combination thereof. In some examples, the indication is valid for a time period.

In some examples, to support receiving the indication, the precoding configuration manager 755 may be configured as or otherwise support a means for receiving an indication of a precoding configuration for the message from the transmitting device, the precoding configuration selected from a set of multiple available precoding configurations based on a number of data symbols. In some examples, the non-linear precoding configuration includes a permutation of redundant symbols and data symbols based on a size of the message and a number of the data symbols.

In some examples, the preferred precoding configuration manager 765 may be configured as or otherwise support a means for transmitting an indication of a preferred configuration to the transmitting device, where the configuration is based on the preferred configuration. In some examples, the non-linear precoding configuration includes a number of redundant symbols, a PAPR threshold for data bits associated with the data symbols, a difference between the size of the message using the non-linear precoding configuration and a linear precoding configuration, or any combination thereof.

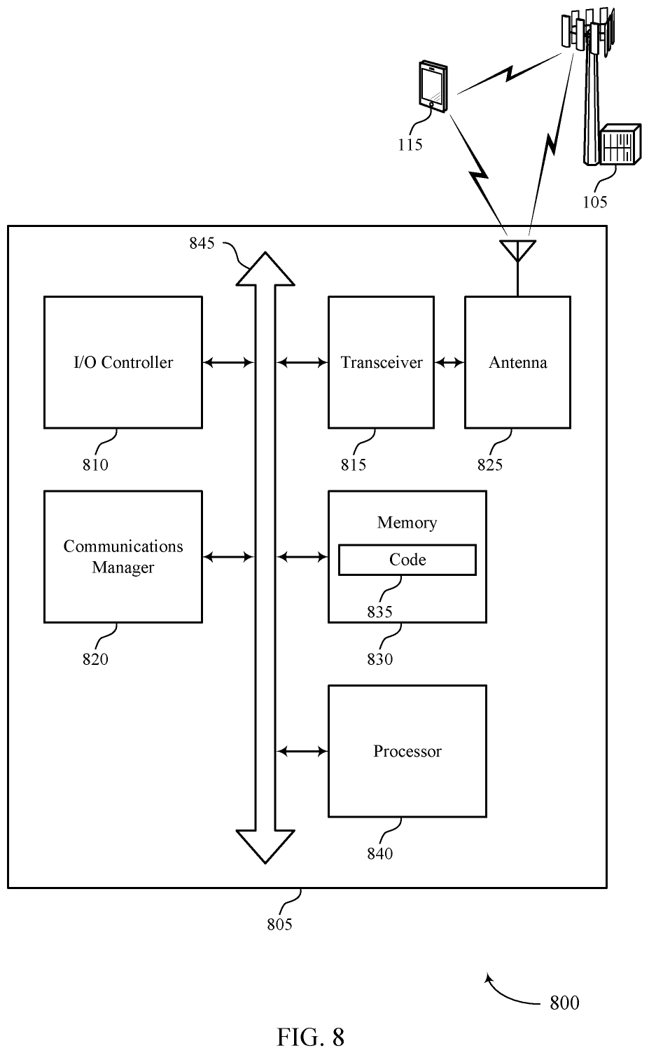

FIG. 8 shows a diagram of a system 800 including a device 805 that supports non-linear data to redundant symbol mapping in accordance with aspects of the present disclosure. The device 805 may be an example of or include the components of a device 505, a device 605, or a UE 115 as described herein. The device 805 may communicate wirelessly with one or more base stations 105, UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting non-linear data to redundant symbol mapping). For example, the device 805 or a component of the device 805 may include a processor 840 and memory 830 coupled with or to the processor 840, the processor 840 and memory 830 configured to perform various functions described herein.

The communications manager 820 may support wireless communication at a transmitting device in accordance with examples as disclosed herein. For example, the communications manager 820 may be configured as or otherwise support a means for precoding, according to a configuration, redundant symbols and data symbols to generate a message, the configuration including a non-linear precoding configuration. The communications manager 820 may be configured as or otherwise support a means for transmitting, to a receiving device, an indication of the configuration. The communications manager 820 may be configured as or otherwise support a means for transmitting the message to the receiving device according to the configuration.

Additionally or alternatively, the communications manager 820 may support wireless communication at a receiving device in accordance with examples as disclosed herein. For example, the communications manager 820 may be configured as or otherwise support a means for receiving, from a transmitting device, an indication of a configuration, the configuration including a non-linear precoding configuration. The communications manager 820 may be configured as or otherwise support a means for receiving the message from the transmitting device according to the configuration, the message including redundant symbols and data symbols. The communications manager 820 may be configured as or otherwise support a means for decoding the message according to the non-linear precoding configuration.

By including or configuring the communications manager 820 in accordance with examples as described herein, the device 805 may support techniques for enabling multi-purpose waveform designs where the transmitting and receiving devices are in sync regarding the non-linear precoding configuration used to generate the message.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described herein with reference to the communications manager 820 may be supported by or performed by the processor 840, the memory 830, the code 835, or any combination thereof. For example, the code 835 may include instructions executable by the processor 840 to cause the device 805 to perform various aspects of non-linear data to redundant symbol mapping as described herein, or the processor 840 and the memory 830 may be otherwise configured to perform or support such operations.

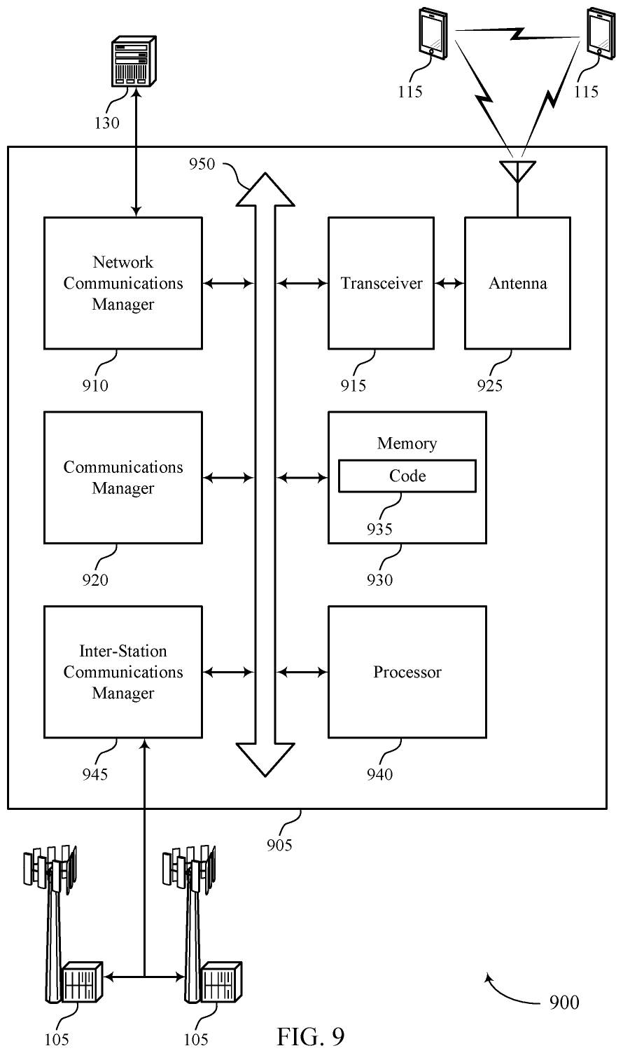

FIG. 9 shows a diagram of a system 900 including a device 905 that supports non-linear data to redundant symbol mapping in accordance with aspects of the present disclosure. The device 905 may be an example of or include the components of a device 505, a device 605, or a base station 105 as described herein. The device 905 may communicate wirelessly with one or more base stations 105, UEs 115, or any combination thereof. The device 905 may include components for bi-directional voice and data communications including components for transmitting and receiving communications, such as a communications manager 920, a network communications manager 910, a transceiver 915, an antenna 925, a memory 930, code 935, a processor 940, and an inter-station communications manager 945. These components may be in electronic communication or otherwise coupled (e.g., operatively, communicatively, functionally, electronically, electrically) via one or more buses (e.g., a bus 950).

The network communications manager 910 may manage communications with a core network 130 (e.g., via one or more wired backhaul links). For example, the network communications manager 910 may manage the transfer of data communications for client devices, such as one or more UEs 115.

In some cases, the device 905 may include a single antenna 925. However, in some other cases the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 515, a transmitter 615, a receiver 510, a receiver 610, or any combination thereof or component thereof, as described herein.

The memory 930 may include RAM and ROM. The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a BIOS which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting non-linear data to redundant symbol mapping). For example, the device 905 or a component of the device 905 may include a processor 940 and memory 930 coupled with or to the processor 940, the processor 940 and memory 930 configured to perform various functions described herein.

The inter-station communications manager 945 may manage communications with other base stations 105, and may include a controller or scheduler for controlling communications with UEs 115 in cooperation with other base stations 105. For example, the inter-station communications manager 945 may coordinate scheduling for transmissions to UEs 115 for various interference mitigation techniques such as beamforming or joint transmission. In some examples, the inter-station communications manager 945 may provide an X2 interface within an LTE/LTE-A wireless communications network technology to provide communication between base stations 105.

The communications manager 920 may support wireless communication at a transmitting device in accordance with examples as disclosed herein. For example, the communications manager 920 may be configured as or otherwise support a means for precoding, according to a configuration, redundant symbols and data symbols to generate a message, the configuration including a non-linear precoding configuration. The communications manager 920 may be configured as or otherwise support a means for transmitting, to a receiving device, an indication of the configuration. The communications manager 920 may be configured as or otherwise support a means for transmitting the message to the receiving device according to the configuration.

Additionally or alternatively, the communications manager 920 may support wireless communication at a receiving device in accordance with examples as disclosed herein. For example, the communications manager 920 may be configured as or otherwise support a means for receiving, from a transmitting device, an indication of a configuration, the configuration including a non-linear precoding configuration. The communications manager 920 may be configured as or otherwise support a means for receiving the message from the transmitting device according to the configuration, the message including redundant symbols and data symbols. The communications manager 920 may be configured as or otherwise support a means for decoding the message according to the non-linear precoding configuration.

By including or configuring the communications manager 920 in accordance with examples as described herein, the device 905 may support techniques for enabling multi-purpose waveform designs where the transmitting and receiving devices are in sync regarding the non-linear precoding configuration used to generate the message.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described herein with reference to the communications manager 920 may be supported by or performed by the processor 940, the memory 930, the code 935, or any combination thereof. For example, the code 935 may include instructions executable by the processor 940 to cause the device 905 to perform various aspects of non-linear data to redundant symbol mapping as described herein, or the processor 940 and the memory 930 may be otherwise configured to perform or support such operations.

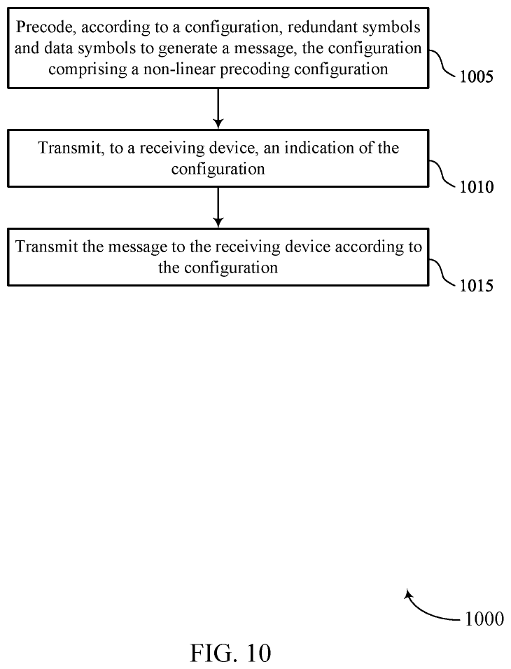

FIG. 10 shows a flowchart illustrating a method 1000 that supports non-linear data to redundant symbol mapping in accordance with aspects of the present disclosure. The operations of the method 1000 may be implemented by a UE or a base station or its components as described herein. For example, the operations of the method 1000 may be performed by a UE 115 or a base station 105 as described herein with reference to FIGS. 1 through 9. In some examples, a UE or a base station may execute a set of instructions to control the functional elements of the UE or the base station to perform the described functions. Additionally or alternatively, the UE or the base station may perform aspects of the described functions using special-purpose hardware.

At 1005, the method may include precoding, according to a configuration, redundant symbols and data symbols to generate a message, the configuration including a non-linear precoding configuration. The operations of 1005 may be performed in accordance with examples as disclosed herein. In some examples, aspects of the operations of 1005 may be performed by a precoding manager 725 as described herein with reference to FIG. 7.

At 1010, the method may include transmitting, to a receiving device, an indication of the configuration. The operations of 1010 may be performed in accordance with examples as disclosed herein. In some examples, aspects of the operations of 1010 may be performed by an indication manager 730 as described herein with reference to FIG. 7.

At 1015, the method may include transmitting the message to the receiving device according to the configuration. The operations of 1015 may be performed in accordance with examples as disclosed herein. In some examples, aspects of the operations of 1015 may be performed by a message manager 735 as described herein with reference to FIG. 7.

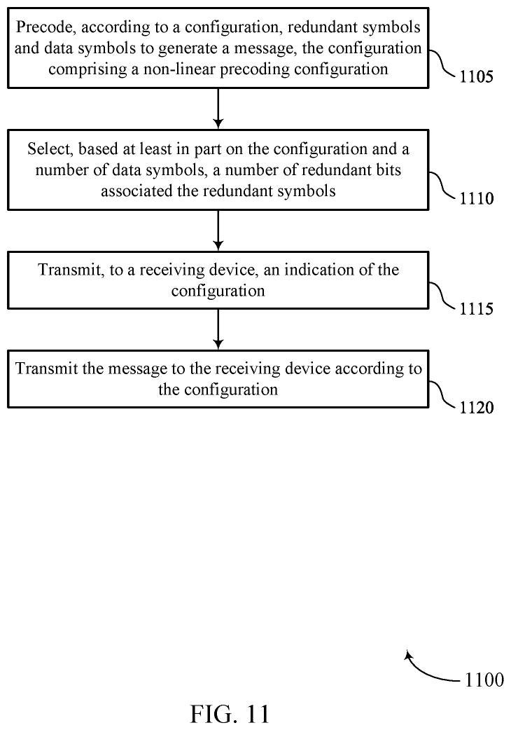

FIG. 11 shows a flowchart illustrating a method 1100 that supports non-linear data to redundant symbol mapping in accordance with aspects of the present disclosure. The operations of the method 1100 may be implemented by a UE or a base station or its components as described herein. For example, the operations of the method 1100 may be performed by a UE 115 or a base station 105 as described herein with reference to FIGS. 1 through 9. In some examples, a UE or a base station may execute a set of instructions to control the functional elements of the UE or the base station to perform the described functions. Additionally or alternatively, the UE or the base station may perform aspects of the described functions using special-purpose hardware.

At 1105, the method may include precoding, according to a configuration, redundant symbols and data symbols to generate a message, the configuration including a non-linear precoding configuration. The operations of 1105 may be performed in accordance with examples as disclosed herein. In some examples, aspects of the operations of 1105 may be performed by a precoding manager 725 as described herein with reference to FIG. 7.

At 1110, the method may include selecting, based on the configuration and a number of data symbols, a number of redundant bits associated the redundant symbols. The operations of 1110 may be performed in accordance with examples as disclosed herein. In some examples, aspects of the operations of 1110 may be performed by a data symbol manager 745 as described herein with reference to FIG. 7.

At 1115, the method may include transmitting, to a receiving device, an indication of the configuration. The operations of 1115 may be performed in accordance with examples as disclosed herein. In some examples, aspects of the operations of 1115 may be performed by an indication manager 730 as described herein with reference to FIG. 7.

At 1120, the method may include transmitting the message to the receiving device according to the configuration. The operations of 1120 may be performed in accordance with examples as disclosed herein. In some examples, aspects of the operations of 1120 may be performed by a message manager 735 as described herein with reference to FIG. 7.

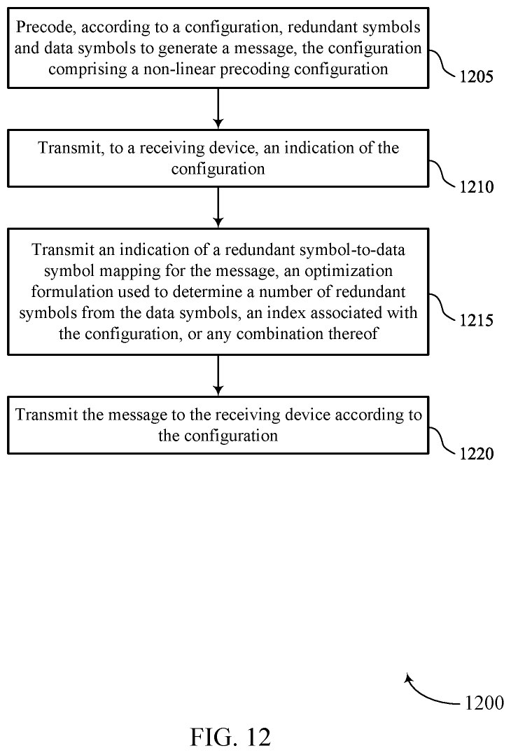

FIG. 12 shows a flowchart illustrating a method 1200 that supports non-linear data to redundant symbol mapping in accordance with aspects of the present disclosure. The operations of the method 1200 may be implemented by a UE or a base station or its components as described herein. For example, the operations of the method 1200 may be performed by a UE 115 or a base station 105 as described herein with reference to FIGS. 1 through 9. In some examples, a UE or a base station may execute a set of instructions to control the functional elements of the UE or the base station to perform the described functions. Additionally or alternatively, the UE or the base station may perform aspects of the described functions using special-purpose hardware.

At 1205, the method may include precoding, according to a configuration, redundant symbols and data symbols to generate a message, the configuration including a non-linear precoding configuration. The operations of 1205 may be performed in accordance with examples as disclosed herein. In some examples, aspects of the operations of 1205 may be performed by a precoding manager 725 as described herein with reference to FIG. 7.

At 1210, the method may include transmitting, to a receiving device, an indication of the configuration. The operations of 1210 may be performed in accordance with examples as disclosed herein. In some examples, aspects of the operations of 1210 may be performed by an indication manager 730 as described herein with reference to FIG. 7.

At 1215, the method may include transmitting an indication of a redundant symbol-to-data symbol mapping for the message, an optimization formulation used to determine a number of redundant symbols from the data symbols, an index associated with the configuration, or any combination thereof. The operations of 1215 may be performed in accordance with examples as disclosed herein. In some examples, aspects of the operations of 1215 may be performed by a mapping indication manager 750 as described with reference to FIG. 7.

At 1220, the method may include transmitting the message to the receiving device according to the configuration. The operations of 1220 may be performed in accordance with examples as disclosed herein. In some examples, aspects of the operations of 1220 may be performed by a message manager 735 as described with reference to FIG. 7.

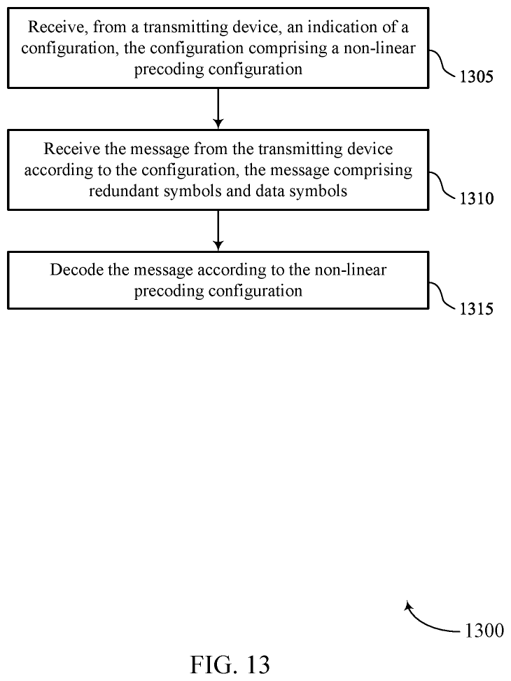

FIG. 13 shows a flowchart illustrating a method 1300 that supports non-linear data to redundant symbol mapping in accordance with aspects of the present disclosure. The operations of the method 1300 may be implemented by a UE or a base station or its components as described herein. For example, the operations of the method 1300 may be performed by a UE 115 or a base station 105 as described with reference to FIGS. 1 through 9. In some examples, a UE or a base station may execute a set of instructions to control the functional elements of the UE or the base station to perform the described functions. Additionally or alternatively, the UE or the base station may perform aspects of the described functions using special-purpose hardware.

At 1305, the method may include receiving, from a transmitting device, an indication of a configuration, the configuration including a non-linear precoding configuration. The operations of 1305 may be performed in accordance with examples as disclosed herein. In some examples, aspects of the operations of 1305 may be performed by an indication manager 730 as described with reference to FIG. 7.

At 1310, the method may include receiving the message from the transmitting device according to the configuration, the message including redundant symbols and data symbols. The operations of 1310 may be performed in accordance with examples as disclosed herein. In some examples, aspects of the operations of 1310 may be performed by a message manager 735 as described with reference to FIG. 7.

At 1315, the method may include decoding the message according to the non-linear precoding configuration. The operations of 1315 may be performed in accordance with examples as disclosed herein. In some examples, aspects of the operations of 1315 may be performed by an encoding manager 740 as described with reference to FIG. 7.

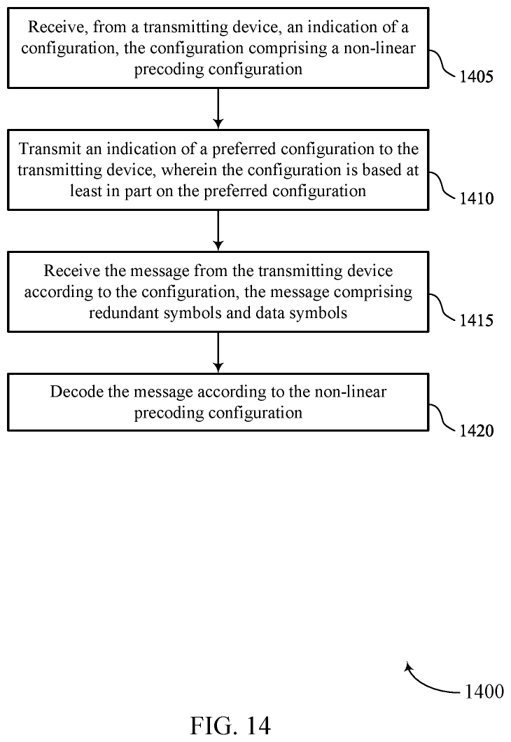

FIG. 14 shows a flowchart illustrating a method 1400 that supports non-linear data to redundant symbol mapping in accordance with aspects of the present disclosure. The operations of the method 1400 may be implemented by a UE or a base station or its components as described herein. For example, the operations of the method 1400 may be performed by a UE 115 or a base station 105 as described with reference to FIGS. 1 through 9. In some examples, a UE or a base station may execute a set of instructions to control the functional elements of the UE or the base station to perform the described functions. Additionally or alternatively, the UE or the base station may perform aspects of the described functions using special-purpose hardware.

At 1405, the method may include receiving, from a transmitting device, an indication of a configuration, the configuration including a non-linear precoding configuration. The operations of 1405 may be performed in accordance with examples as disclosed herein. In some examples, aspects of the operations of 1405 may be performed by an indication manager 730 as described with reference to FIG. 7.

At 1410, the method may include transmitting an indication of a preferred configuration to the transmitting device, where the configuration is based on the preferred configuration. The operations of 1410 may be performed in accordance with examples as disclosed herein. In some examples, aspects of the operations of 1410 may be performed by a preferred precoding configuration manager 765 as described with reference to FIG. 7.

At 1415, the method may include receiving the message from the transmitting device according to the configuration, the message including redundant symbols and data symbols. The operations of 1415 may be performed in accordance with examples as disclosed herein. In some examples, aspects of the operations of 1415 may be performed by a message manager 735 as described with reference to FIG. 7.

At 1420, the method may include decoding the message according to the non-linear precoding configuration. The operations of 1420 may be performed in accordance with examples as disclosed herein. In some examples, aspects of the operations of 1420 may be performed by an encoding manager 740 as described with reference to FIG. 7.

The following provides an overview of aspects of the present disclosure:

Aspect 1: A method for wireless communication at a transmitting device, comprising: precoding, according to a configuration, redundant symbols and data symbols to generate a message, the configuration comprising a non-linear precoding configuration; transmitting, to a receiving device, an indication of the configuration; and transmitting the message to the receiving device according to the configuration.

Aspect 2: The method of aspect 1, further comprising: selecting, based at least in part on the configuration and a number of data symbols, a number of redundant bits associated the redundant symbols.

Aspect 3: The method of any of aspects 1 through 2, wherein transmitting the indication of the configuration comprises: transmitting an indication of a redundant symbol-to-data symbol mapping for the message, an optimization formulation used to determine a number of redundant symbols from the data symbols, an index associated with the configuration, or any combination thereof.

Aspect 4: The method of aspect 3, wherein the indication is transmitted in a DCI message, an RRC message, a MAC-CE message, a SCI message, or any combination thereof.

Aspect 5: The method of any of aspects 3 through 4, wherein the indication is valid for a time period.

Aspect 6: The method of any of aspects 1 through 5, further comprising: selecting a precoding configuration from a plurality of available precoding configurations based at least in part on a number of data symbols.

Aspect 7: The method of aspect 6, wherein transmitting the indication of the configuration comprises: transmitting an indication of the precoding configuration.

Aspect 8: The method of any of aspects 1 through 7, wherein the non-linear precoding configuration comprises: permutating redundant symbols and data bits associated with the data symbols based at least in part on a size of the message and a number of the data symbols.

Aspect 9: The method of any of aspects 1 through 8, further comprising: receiving an indication of a preferred configuration from the receiving device, wherein the configuration is based at least in part on the preferred configuration.

Aspect 10: The method of any of aspects 1 through 9, wherein the non-linear precoding configuration comprises a number of redundant symbols, a PAPR threshold for data bits associated with the data symbols, a difference between a size of the message using the non-linear precoding configuration and a linear precoding configuration, or any combination thereof.

Aspect 11: A method for wireless communication at a receiving device, comprising: receiving, from a transmitting device, an indication of a configuration, the configuration comprising a non-linear precoding configuration; receiving a message from the transmitting device according to the configuration, the message comprising redundant symbols and data symbols; and decoding the message according to the non-linear precoding configuration.

Aspect 12: The method of aspect 11, wherein decoding the message comprises: identifying a number of redundant symbols based at least in part on the configuration and a number of data symbols.

Aspect 13: The method of any of aspects 11 through 12, wherein receiving the indication of the configuration comprises: receiving an indication of a redundant symbol-to-data symbol mapping for the message, an optimization formulation used to determine the redundant symbols from the data symbols, an index associated with the configuration, or any combination thereof.

Aspect 14: The method of aspect 13, wherein the indication is received in a DCI message, an RRC message, a MAC-CE message, a SCI message, or any combination thereof.

Aspect 15: The method of any of aspects 13 through 14, wherein the indication is valid for a time period.

Aspect 16: The method of any of aspects 11 through 15, wherein receiving the indication comprises: receiving an indication of a precoding configuration for the message from the transmitting device, the precoding configuration selected from a plurality of available precoding configurations based at least in part on a number of data symbols.

Aspect 17: The method of any of aspects 11 through 16, wherein the non-linear precoding configuration comprises a permutation of redundant symbols and data symbols based at least in part on a size of the message and a number of the data symbols.

Aspect 18: The method of any of aspects 11 through 17, further comprising: transmitting an indication of a preferred configuration to the transmitting device, wherein the configuration is based at least in part on the preferred configuration.

Aspect 19: The method of any of aspects 11 through 18, wherein the non-linear precoding configuration comprises a number of redundant symbols, a PAPR threshold for data bits associated with the data symbols, a difference between a size of the message using the non-linear precoding configuration and a linear precoding configuration, or any combination thereof.

Aspect 20: An apparatus for wireless communication at a transmitting device, comprising a processor; memory coupled with the processor; and instructions stored in the memory and executable by the processor to cause the apparatus to perform a method of any of aspects 1 through 10.

Aspect 21: An apparatus for wireless communication at a transmitting device, comprising at least one means for performing a method of any of aspects 1 through 10.

Aspect 22: A non-transitory computer-readable medium storing code for wireless communication at a transmitting device, the code comprising instructions executable by a processor to perform a method of any of aspects 1 through 10.

Aspect 23: An apparatus for wireless communication at a receiving device, comprising a processor; memory coupled with the processor; and instructions stored in the memory and executable by the processor to cause the apparatus to perform a method of any of aspects 11 through 19.

Aspect 24: An apparatus for wireless communication at a receiving device, comprising at least one means for performing a method of any of aspects 11 through 19.

Aspect 25: A non-transitory computer-readable medium storing code for wireless communication at a receiving device, the code comprising instructions executable by a processor to perform a method of any of aspects 11 through 19.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a transmitting device, comprising:
a processor; and
a memory coupled with the processor, with instructions stored in the memory and executable by the processor to cause the apparatus to:
precode, according to a configuration, redundant symbols and data symbols to generate a message, the configuration comprising a non-linear precoding configuration;
transmit, to a receiving device, an indication of the configuration; and
transmit the message to the receiving device according to the configuration.

2. The apparatus of claim 1, wherein the instructions are further executable by the processor to cause the apparatus to:
select, based at least in part on the configuration and a number of data symbols, a number of redundant bits associated the redundant symbols.

3. The apparatus of claim 1, wherein the instructions to transmit the indication of the configuration are executable by the processor to cause the apparatus to:
transmit an indication of a redundant symbol-to-data symbol mapping for the message, an optimization formulation used to determine a number of redundant symbols from the data symbols, an index associated with the configuration, or any combination thereof.

4. The apparatus of claim 3, wherein the indication is transmitted in a downlink control information (DCI) message, a radio resource control (RRC) message, a medium access control-control element (MAC-CE) message, a sidelink control information (SCI) message, or any combination thereof.

5. The apparatus of claim 3, wherein the indication is valid for a time period.

6. The apparatus of claim 1, wherein the instructions are further executable by the processor to cause the apparatus to:
select a precoding configuration from a plurality of available precoding configurations based at least in part on a number of data symbols.

7. The apparatus of claim 6, wherein the instructions to transmit the indication of the configuration are executable by the processor to cause the apparatus to:
transmit an indication of the precoding configuration.

8. The apparatus of claim 1, wherein the instructions to precode the configuration comprising the non-linear precoding configuration are executable by the processor to cause the apparatus to:
permutate redundant symbols and data bits associated with the data symbols based at least in part on a size of the message and a number of the data symbols.

9. The apparatus of claim 1, wherein the instructions are further executable by the processor to cause the apparatus to:
receive an indication of a preferred configuration from the receiving device, wherein the configuration is based at least in part on the preferred configuration.

10. The apparatus of claim 1, wherein the non-linear precoding configuration comprises a number of redundant symbols, a peak-to-average-power ratio (PAPR) threshold for data bits associated with the data symbols, a difference between a size of the message using the non-linear precoding configuration and a linear precoding configuration, or any combination thereof.

11. An apparatus for wireless communication at a receiving device, comprising:
a processor; and
memory coupled with the processor, with instructions stored in the memory and executable by the processor to cause the apparatus to:
receive, from a transmitting device, an indication of a configuration, the configuration comprising a non-linear precoding configuration;
receive a message from the transmitting device according to the configuration, the message comprising redundant symbols and data symbols; and
decode the message according to the non-linear precoding configuration.

12. The apparatus of claim 11, wherein the instructions to decode the message are executable by the processor to cause the apparatus to:
identify a number of redundant symbols based at least in part on the configuration and a number of data symbols.

13. The apparatus of claim 11, wherein the instructions to receive the indication of the configuration are executable by the processor to cause the apparatus to:
receive an indication of a redundant symbol-to-data symbol mapping for the message, an optimization formulation used to determine the redundant symbols from the data symbols, an index associated with the configuration, or any combination thereof.

14. The apparatus of claim 13, wherein the indication is received in a downlink control information (DCI) message, a radio resource control (RRC) message, a medium access control-control element (MAC-CE) message, a sidelink control information (SCI) message, or any combination thereof.

15. The apparatus of claim 13, wherein the indication is valid for a time period.

16. The apparatus of claim 11, wherein the instructions to receive the indication are executable by the processor to cause the apparatus to:
receive an indication of a precoding configuration for the message from the transmitting device, the precoding configuration selected from a plurality of available precoding configurations based at least in part on a number of data symbols.

17. The apparatus of claim 11, wherein the non-linear precoding configuration comprises a permutation of redundant symbols and data symbols based at least in part on a size of the message and a number of the data symbols.

18. The apparatus of claim 11, wherein the instructions are further executable by the processor to cause the apparatus to:
transmit an indication of a preferred configuration to the transmitting device, wherein the configuration is based at least in part on the preferred configuration.

19. The apparatus of claim 11, wherein the non-linear precoding configuration comprises a number of redundant symbols, a peak-to-average-power ratio (PAPR) threshold for data bits associated with the data symbols, a difference between a size of the message using the non-linear precoding configuration and a linear precoding configuration, or any combination thereof.

20. A method for wireless communication at a transmitting device, comprising:
precoding, according to a configuration, redundant symbols and data symbols to generate a message, the configuration comprising a non-linear precoding configuration;
transmitting, to a receiving device, an indication of the configuration; and
transmitting the message to the receiving device according to the configuration.

21. The method of claim 20, further comprising:
selecting, based at least in part on the configuration and a number of data symbols, a number of redundant bits associated the redundant symbols.

22. The method of claim 20, wherein transmitting the indication of the configuration comprises:
transmitting an indication of a redundant symbol-to-data symbol mapping for the message, an optimization formulation used to determine a number of redundant symbols from the data symbols, an index associated with the configuration, or any combination thereof.

23. The method of claim 22, wherein the indication is transmitted in a downlink control information (DCI) message, a radio resource control (RRC) message, a medium access control-control element (MAC-CE) message, a sidelink control information (SCI) message, or any combination thereof.

24. The method of claim 22, wherein the indication is valid for a time period.

25. The method of claim 20, further comprising:
selecting a precoding configuration from a plurality of available precoding configurations based at least in part on a number of data symbols.

26. The method of claim 25, wherein transmitting the indication of the configuration comprises:
transmitting an indication of the precoding configuration.

27. The method of claim 20, wherein precoding the configuration comprising the non-linear precoding configuration comprises:
permutating redundant symbols and data bits associated with the data symbols based at least in part on a size of the message and a number of the data symbols.

28. The method of claim 20, further comprising:
receiving an indication of a preferred configuration from the receiving device, wherein the configuration is based at least in part on the preferred configuration.

29. The method of claim 20, wherein the non-linear precoding configuration comprises a number of redundant symbols, a peak-to-average-power ratio (PAPR) threshold for data bits associated with the data symbols, a difference between a size of the message using the non-linear precoding configuration and a linear precoding configuration, or any combination thereof.

30. A method for wireless communication at a receiving device, comprising:
receiving, from a transmitting device, an indication of a configuration, the configuration comprising a non-linear precoding configuration;
receiving a message from the transmitting device according to the configuration, the message comprising redundant symbols and data symbols; and
decoding the message according to the non-linear precoding configuration.
